(19) United States
(12) Patent Application Publication
(10) Pub. No.: US 2013/0314398 A1
(43) Pub. Date: Nov. 28, 2013

(54) AUGMENTED REALITY USING STATE PLANE COORDINATES

(71) Applicants: Michael LeMoyne Coates, University Place, WA (US); Victor Michael Zefas, Port Orchard, WA (US); Juan Pablo Montano, Auburn, WA (US)

(72) Inventors: Michael LeMoyne Coates, University Place, WA (US); Victor Michael Zefas, Port Orchard, WA (US); Juan Pablo Montano, Auburn, WA (US)

(73) Assignee: INFINICORP LLC, Auburn, WA (US)

(21) Appl. No.: 13/480,362

(22) Filed: May 24, 2012

(51) Int. Cl. G09G 5/00; G06T 15/00

(52) U.S. Cl. 345/419; 345/633

(57) ABSTRACT

An augmented reality (AR) is displayed that combines a real world view with a display of virtual objects. A user may view the virtual objects from different perspectives (e.g. in front of the object, behind the object, to the side of the object, on top of the object, below the object, inside the object). The AR view uses current location information (e.g. GPS coordinates, current elevation . . . ) that is converted to the State Plane Coordinate System (SPCS) to assist in determining the virtual objects to display. A geofence may be configured that defines boundaries for when a virtual object(s) is to be displayed. An area defined by a geofence may be associated with one of more defined virtual objects. A defined boundary may be exclusive or non-exclusive. Exclusive boundaries are associated with virtual objects from authorized entities whereas non-exclusive boundaries may be associated with virtual objects from any number of entities.

### BACKGROUND

Virtual reality (VR) systems and heads up displays (HUD) are becoming more commonly used. For example, HUDs may be used to display data on a windshield to provide the user with more information (e.g. speed, coordinates) than what can be normally seen out of the windshield by the user. VR systems in which a virtual world is displayed may be used for gaming, training, and/or other purposes. These systems can be expensive, difficult to use and not very accurate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An augmented reality (AR) is displayed that combines a real world camera view with a display of virtual objects. A user may view the virtual objects from different perspectives (e.g. in front of the object, behind the object, to the side of the object, on top of the object, below the object, from within the object, and the like). The AR view uses current location information (e.g. GPS coordinates, current elevation . . . ) that is converted to the State Plane Coordinate System (SPCS) to assist in determining where to display the virtual objects on the device display. Virtual objects may be selected for display based on different criteria (e.g. location information). For example, a virtual object may come into view (or disappear from view) when: a user enters a specific area (e.g. room, geofenced region); when a virtual object is within the current field of view; when the virtual object is within a predetermined distance from the user; and the like. A geofence may be configured that defines boundaries for when a virtual object(s) is to be displayed or hidden. An area defined by a geofence may be associated with one of more defined virtual objects. For example, a company may be associated with a defined area and when a user is located with the defined area, virtual objects are displayed. A defined boundary may be exclusive or non-exclusive. Exclusive boundaries are associated with virtual objects from authorized entities whereas non-exclusive boundaries may be associated with virtual objects from any number of entities.

### BRIEF DESCRIPTION OF THE DRAWINGS

FIG. 1 illustrates an exemplary computing device;

FIG. 2 illustrates an example system for augmented reality using SPCS;

FIG. 3 shows a process for displaying an augmented reality using state plane coordinates;

FIG. 4 shows a process for defining virtual objects;

FIG. 5 shows a process for associating a particular area and virtual objects; and

FIGS. 6-21 show exemplary diagrams illustrating defining and displaying virtual objects within an augmented reality.

### DETAILED DESCRIPTION

Referring now to the drawings, in which like numerals represent like elements, various embodiments will be described.

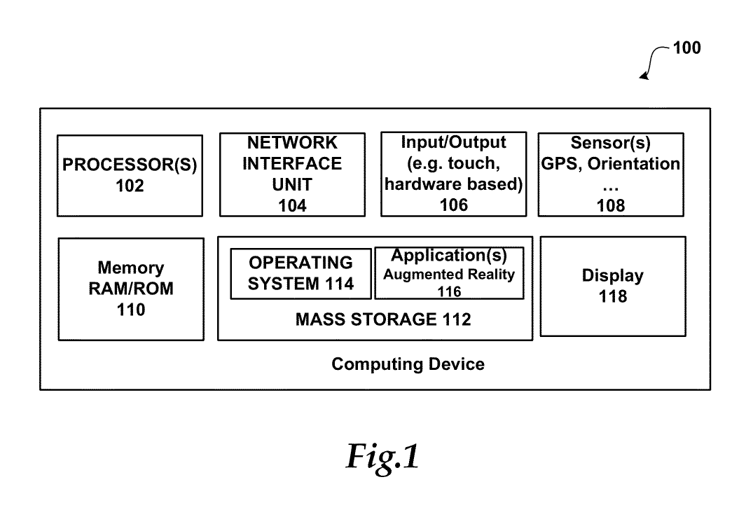

FIG. 1 illustrates an exemplary computing device. As illustrated, computing device 100 comprises processor(s) 102, network interface unit 104, input/output (e.g. touch input, hardware based input . . . ) 106, sensors 108, memory (RAM/ROM) 110, mass storage 112 that stores an operating system 114 and applications 116 (e.g. Augmented Reality (AR) application) and display 118, all connected.

Computing device 100 may connect to a WAN/LAN, a wireless network, or other communications network, using network interface unit 104. Network interface unit 104 may use various communication protocols including the TCP/IP protocol and may include a radio layer (not shown) that is arranged to transmit and receive radio frequency communications. The operating system 114 may be a custom operating system or a general purpose operating system, such as UNIX, LINUX™, MICROSOFT WINDOWS 7®, GOOGLE ANDROID, and the like.

Computing device 100 also comprises input/output interface 106 for receiving input and communicating with external devices (e.g. a mouse, keyboard, scanner, or other input/output devices). Mass storage 112 may store data such as application programs, databases, and other program data.

Sensors 108 assist in determining the location and position of the device. Sensors 108 may include sensors such as accelerometer(s), magnetometer(s) and gyros that may be used to measure an orientation of a device, acceleration, yaw, pitch and roll of the device. One such sensor unit is the \VN-100 sensor from VectorNav Technologies Richardson, Tex.

AR application 116 is configured to display an augmented reality (AR) that combines a real world view with a display of virtual objects. A user may view the virtual objects from different perspectives (e.g. in front of the object, behind the object, to the side of the object, on top of the object, below the object, inside the object). The AR view uses current location information (e.g. GPS coordinates, current elevation . . . ) that is converted to the State Plane Coordinate System (SPCS) to assist in determining where to display the virtual objects on the device display. AR application may display a user interface for configuring a geofence that defines boundaries for when a virtual object(s) is to be displayed or hidden. An area defined by a geofence may be associated with one of more defined virtual objects. For example, a company may be associated a defined area and when a user is located with the defined area, virtual objects are displayed. A defined boundary may be exclusive or non-exclusive. Exclusive boundaries are associated with virtual objects from authorized entities whereas non-exclusive boundaries may be associated with virtual objects from any number of entities

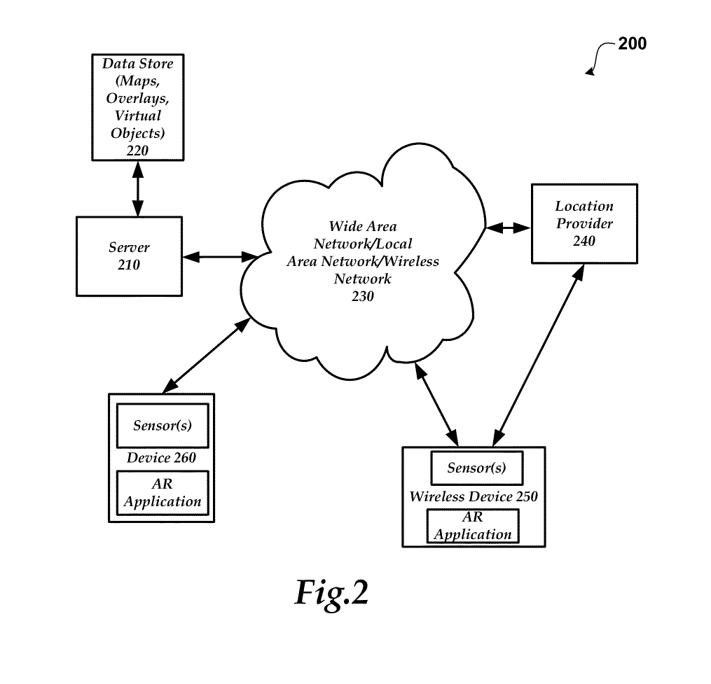

FIG. 2 illustrates an example system for augmented reality using SPCS.

As illustrated, system 200 comprises server 210, data store 220, network 230, location provider 240, wireless touch screen input device/display 250 (e.g. a tablet, smart phone) and device 260. More/fewer devices may be utilized within system 200.

Data store 220 is configured to store map information, virtual objects, virtual object definitions, overlays, and the like. For example, data store 220 may store an overlay relating to pipe locations, property boundary locations, wire locations, building locations, public utilities, and the like. Data store 220 may also store predefined and/or user configured virtual object. For example, the virtual objects may include advertisements, models (e.g. 2D, 3D), animations and the like. Data store 220 may also store the virtual object(s) that are associated with different entities (e.g. users, businesses, cities . . . ).

The devices are configured to provide an augmented reality (AR) view that combines a real time view (e.g. video/camera view) with a display of virtual objects when determined. According to an embodiment, a device (e.g. device 250, 260) connects to a server (e.g. 210) to obtain map and virtual object data. A device may also be configured to store the map and virtual object data on the device itself or at another location. Server 210 may also be configured to convert location information to state plane coordinates. For example, the location information may be GPS information provided by a location provider 240 (e.g. GPS satellites) alone or in combination with other sensor data that may be included on the device (e.g. height of device, pitch, yaw, roll . . . ).

The AR application displays a user interface for navigating an AR view, defining/setting virtual objects, and using a search query to find particular objects within an AR view. Using their device, a user may view virtual objects from different perspectives. Virtual objects may be selected for display based on the current location. For example, a virtual object may come into view when: a user enters a specific area (e.g. room, geofenced region); when a virtual object is within the current field of view; when the virtual object is within a predetermined distance from the user; and the like. A geofence may be configured using a graphical user interface and/or some other input method that defines boundaries for when a virtual object(s) is to be displayed. An area defined by a geofence may be associated with one of more defined virtual objects.

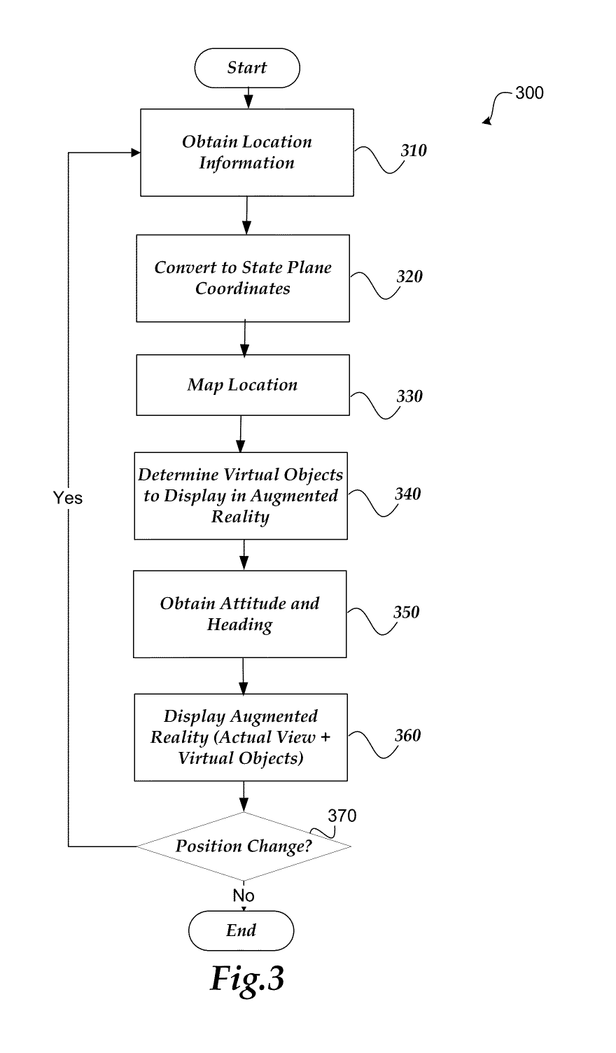

FIGS. 3-5 shows illustrative processes for creating virtual objects and displaying an augmented reality. When reading the discussion of the processes and routines, it should be appreciated that the logical operations of various embodiments may be implemented in software, firmware, in special purpose digital logic, and any combination thereof.

FIG. 3 shows a process for displaying an augmented reality using state plane coordinates.

After a start operation, process 300 flows to operation 310, where location information is obtained. The location information may be obtained from one or more different sources. For example, location information may be obtained from a GPS system that provided GPS coordinates to a device, the location information may be determined from the current view (e.g. coordinating a location for the device using known reference points), the location may be manually entered by the user and/or some combination and/or some other location devices/sensors. According to an embodiment, the device includes various sensors that assist in determining the location and position of the device such as accelerometer(s), magnetometer(s) and gyros that may be used to measure an orientation of a device, acceleration, yaw, pitch and roll of the device.

Moving to operation 320, the location information (e.g. latitude/longitude is converted to the State Plane Coordinate System (SPCS). The SPCS provides a much more accurate representation of points as compared to GPS alone. For example, a specific point on a building may be defined accurately using SPCS as compared to only relying on GPS data.

Flowing to operation 330, the current location is mapped into the augmented reality. The current map may relate to a specific predefined area at varying levels that may be zoomed into and out from. For example, a current map view may show a city block and a zoomed in view may show a street level view at a particular intersection.

Transitioning to operation 340, the virtual objects to display in the augmented reality view are determined. For example, when the current location is within a predetermined area of one or more geofences, the objects within the geofences are displayed or hidden. When the current location is not within/near a geofence, other virtual objects may be displayed or hidden within the augmented reality view. Some objects may not be associated with a geofence. For example, a user or some other entity may define a view of a three-dimensional object to display at a particular point within the view. When the defined virtual object is determined to be within the view, then the virtual object may be displayed. According to an embodiment, a virtual object may be shown as being behind real world objects (e.g. beyond a wall of a building) when a physical barrier would normally prevent its display.

Moving to operation 350, the attitude and heading from which to determine the AR view is determined. For example, the attitude and heading for the display is determined.

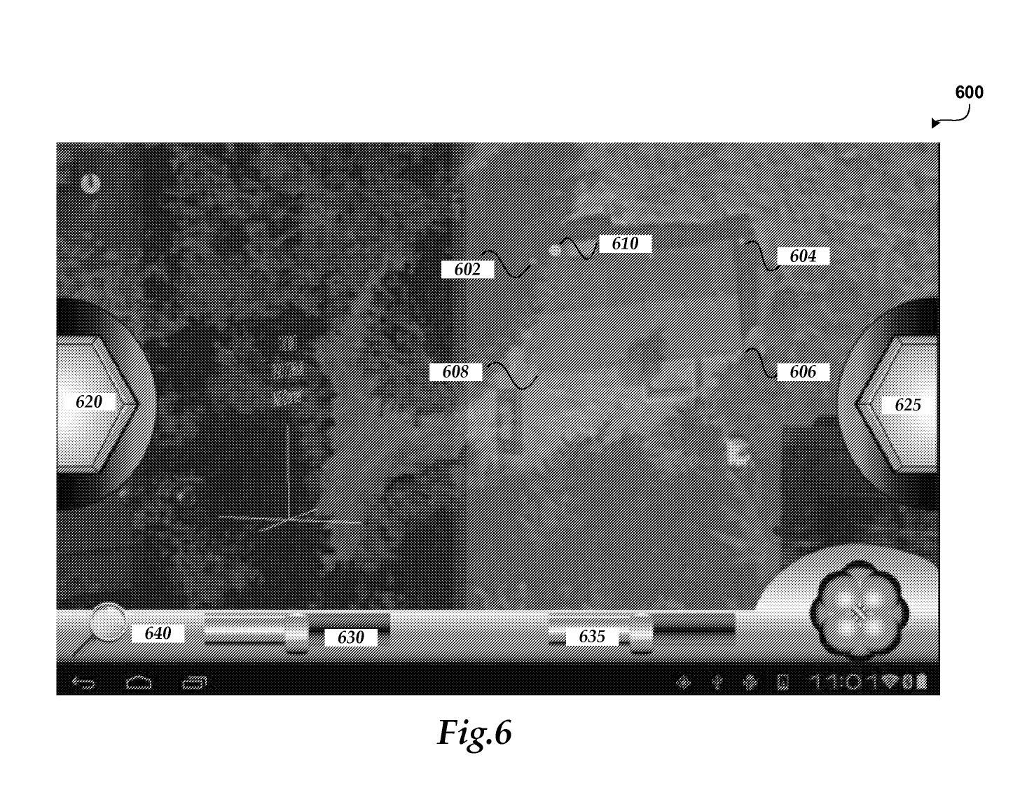

Flowing to operation 360, the augmented reality view is displayed that includes the determined virtual objects (See FIGS. 6-21 for examples).

Moving to decision operation 370, a determination is made as to whether the location/position of the device has changed. When the position does change, the process returns to operation 310 to update the display of the augmented reality. When the position has not changed, the process flows to an end operation, where the process ends and returns to processing other actions.

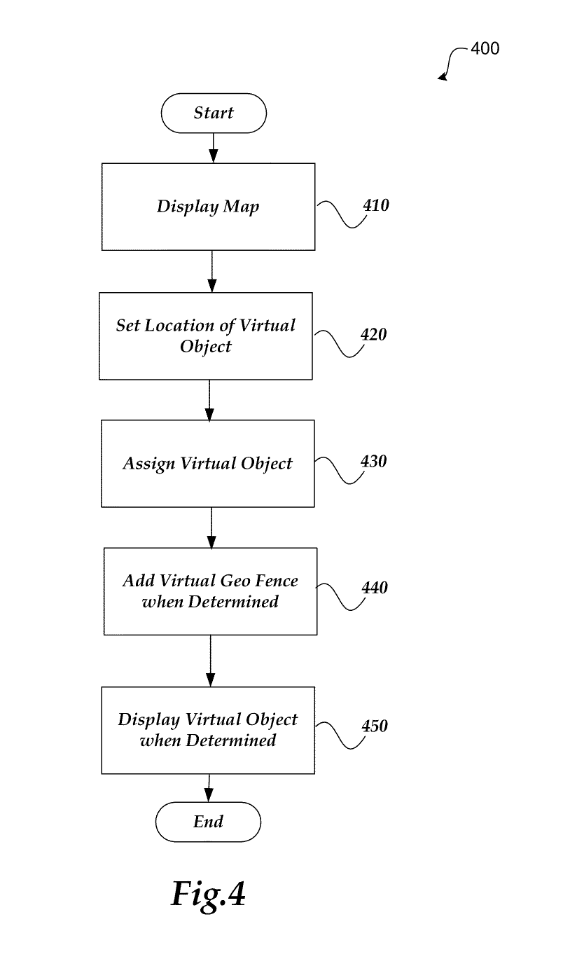

FIG. 4 shows a process for defining virtual objects.

After a start operation, the process flows to operation 410 where a map is displayed. The map may be displayed in different manners and may be a two dimensional and/or three dimensional map. For example, the map may be displayed using a program such as GOOGLE MAPS that allows a user to view maps with/without satellite images, street views and other information. Each location on the map may be associated with a SPC.

Moving to operation 420, the location of the virtual object is set. The location may be set using different methods. For example, a user may select an area on the map (e.g. touch input, hardware input), a call to an API may be made specifying the location, the location of the virtual object may be determined from predefined virtual objects (e.g. an overlay is loaded). For example, a user may select to display virtual objects that represent underground pipes, electrical lines, property lines, buildings, streets, and the like. The location may be specified using two and/or three-dimensional coordinates. For example, a location of a virtual object may be six feet above a surface, six miles below the surface, on a surface, and the like.

Flowing to operation 430, the type of virtual object to display at the set location is assigned. For example, a user may select from a predefined object (e.g. a balloon, a cube, a logo, a picture and thumbtack and other objects). The object may be any graphical object that may be displayed, including animations. For example, an advertisement, instructions, virtual assistants, virtual walls, pictures, and the like. The objects may be determined from a user and/or some other entity. For example, a user may upload one or more virtual objects and a predefined set of default virtual objects may be included to be assigned. A user and/or some other user may also configure/create/modify new/different virtual objects.

Transitioning to operation 440, a geofence may be added. A geofence defines an area for display of the virtual object. According to an embodiment, when the device is within the area defined by the geofence, any virtual objects within that geofence and that are associated with the geofence are either displayed or hidden. The geofence may be defined in three dimensions such that a three dimensional shape defines the parameters of the geofence.

Moving to operation 450, the virtual objects are displayed in the augmented reality when determined.

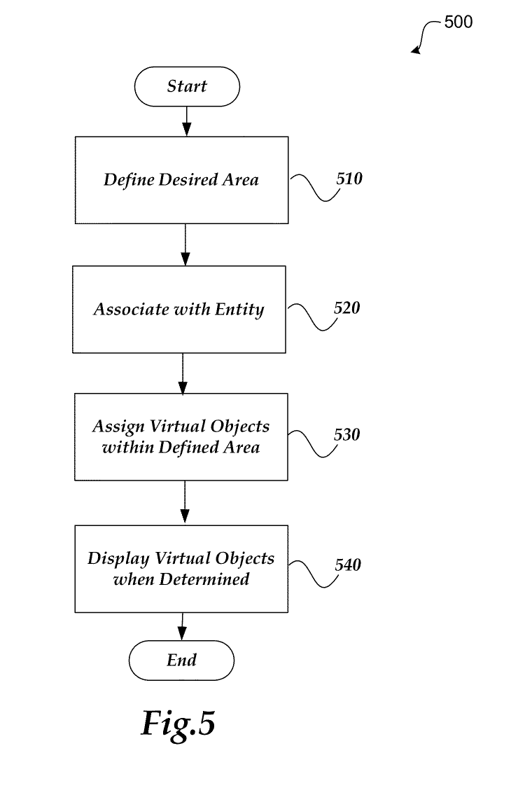

FIG. 5 shows a process for associating a particular area and virtual objects.

After a start operation, the process flows to operation 510, where a desired area is defined. The area may be defined using different methods. For example, one or more geofences may be defined to describe the desired area.

Moving to operation 520, the defined area(s) is associated with an entity (e.g. a customer, user, municipality, and the like). For example, an entity may purchase/rent the defined area such that they may place various virtual objects within the area. Defined areas may be exclusive or nonexclusive. Exclusive areas are associated only with the entity that has been assigned the area whereas nonexclusive areas may be assigned to one or more different entities. For example, in one defined nonexclusive area, a first entity may include a first set of virtual object and a second entity may also include a different set of virtual objects.

Flowing to operation 530, the entity may assign virtual objects within the area.

Transitioning to operation 540, the virtual objects are displayed when determined.

FIGS. 6-21 show exemplary diagrams illustrating defining and displaying virtual objects within an augmented reality.

FIG. 6 shows a satellite map view and exemplary graphical user interface.

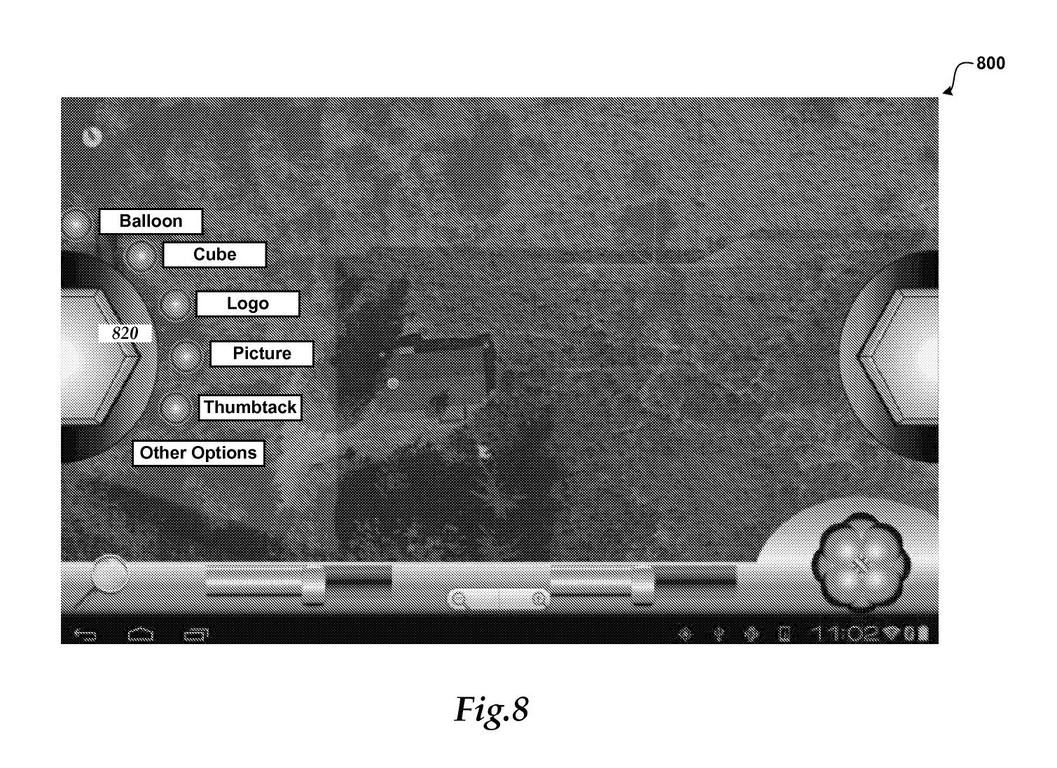

As shown, view 600 shows a display of a house with four marked corners (602, 604, 606 and 608) that are virtual objects that have been defined as well as a current location 610 of a device displaying an AR view. A GUI is also displayed that includes controls 620, 625, 630, 635 and 640. Controls 620 and 625 provide a visual location of where a user may hold the device when adjusting the location of the device to obtain a desired AR view. Options may also be displayed near controls 620 and 625 (See FIG. 8 and related discussion).

Slider 630 adjusts the view from an augmented reality view to a map view which changes from a map view to AR view based on the location of a slider. When the slider 630 is moved to the far right, the view is a map view and when the slider is at the far left location the view is the AR view that includes the real-time camera view along with any virtual objects determined to be displayed. Any intermediate location of slider 630 will show the AR and map views at varying levels of transparency. Slider 635 may be used to zoom in/out from a view.

Search magnifier 640 (e.g. magnifier graphic) is used to search for virtual objects. According to an embodiment, the search area for the virtual objects is based on the current field of view the user sees. For example, selecting search magnifier 640 within the current view would display the virtual objects that are located within the view shown in FIG. 6. Zooming in/out from the current view changes the search scope. For example, zooming out to a city level view would change the search scope to search for the virtual objects located within the city. Zooming in to a house level view changes the search scope to search for the virtual objects within the house. A user may also filter the type of virtual objects that are searched and/or who (e.g. what business, user) is associated with the virtual object. For example, a user may filter to search for virtual objects that are associated with a particular business and/or type of virtual object (e.g. location marker, an ad, a pipe, a window, . . . ).

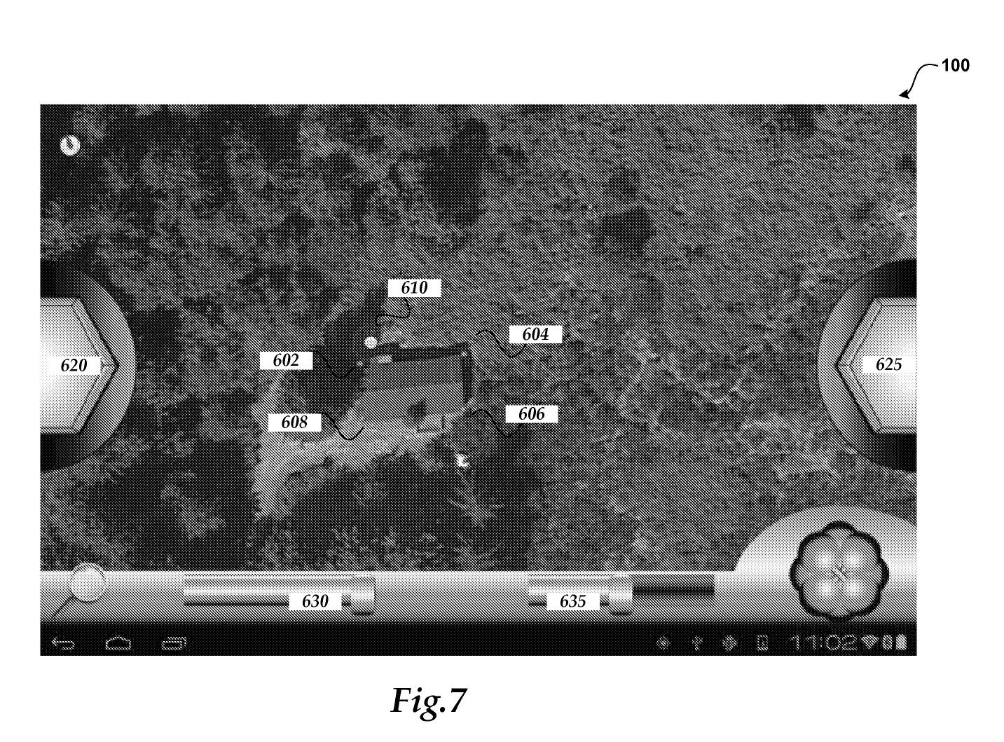

FIG. 7 shows a view 700 where the view is the map view. As can be seen when comparing FIG. 7 to FIG. 6, the map view is much clearer of the house and trees.

FIG. 8 shows setting a type of virtual object. As illustrated, once the user taps a location on the map view 800 shows GUI 820 with different options for setting the type of virtual object. The options are used to select a type of graphical object that represents the determined location for the virtual object. According to an embodiment, the options include a balloon, a cube, a logo, a picture, a thumbtack, and other options. Generally, any type of graphical object may be set to be the type of virtual object. When the other options selection is made, the display shows different options from which a user may obtain further types of virtual objects, import a virtual object and/or create a new graphical object for the virtual object. The graphical object may appear to be a two-dimensional object and/or a three-dimensional object, with animation or not.

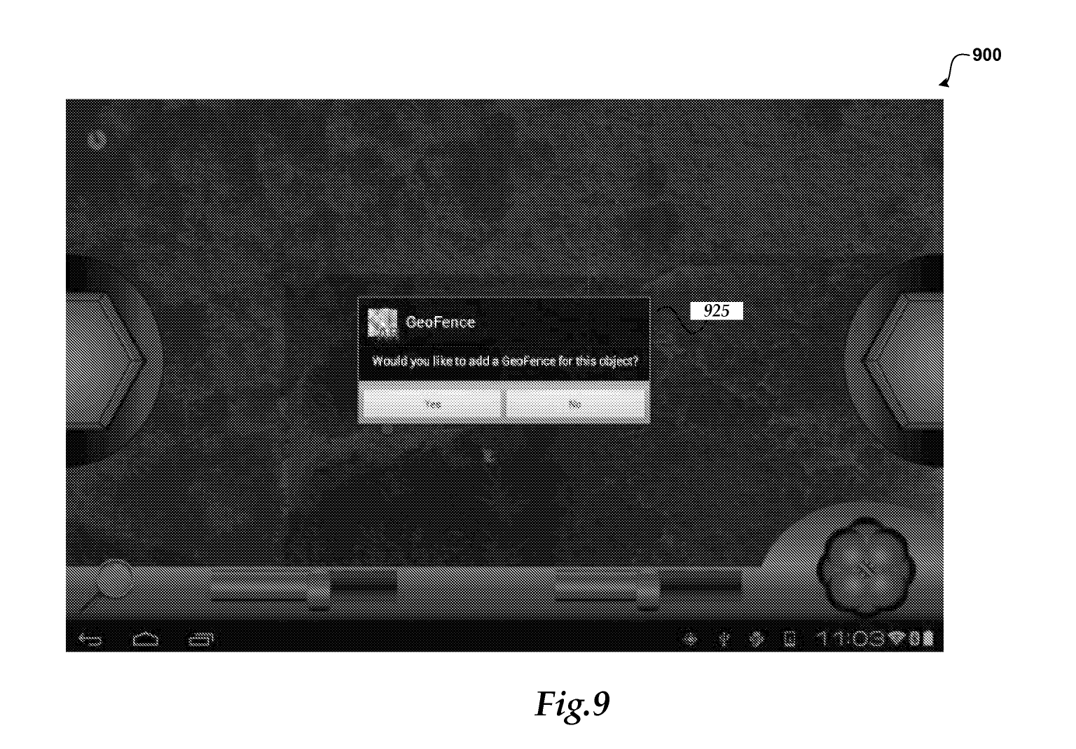

FIG. 9 shows a diagram 900 showing a user interface selection 925 for determining when to define a geofence for an object. When the user does not select to create a geofence then the virtual object is always visible. When the user selects the “Yes” option then the user defines the geofence area in which the virtual object is displayed. According to an embodiment, the user defines a set of X,Y,Z coordinates around the object. The geofence may be defined other ways. For example, the geofence may be initially sized based upon an area that encloses the selection point where to create the object (e.g. sized to a room, building, . . . ). A selectable graphic may also be displayed from which a user may adjust to size the area. A series of coordinates may also be input to size the geofence.

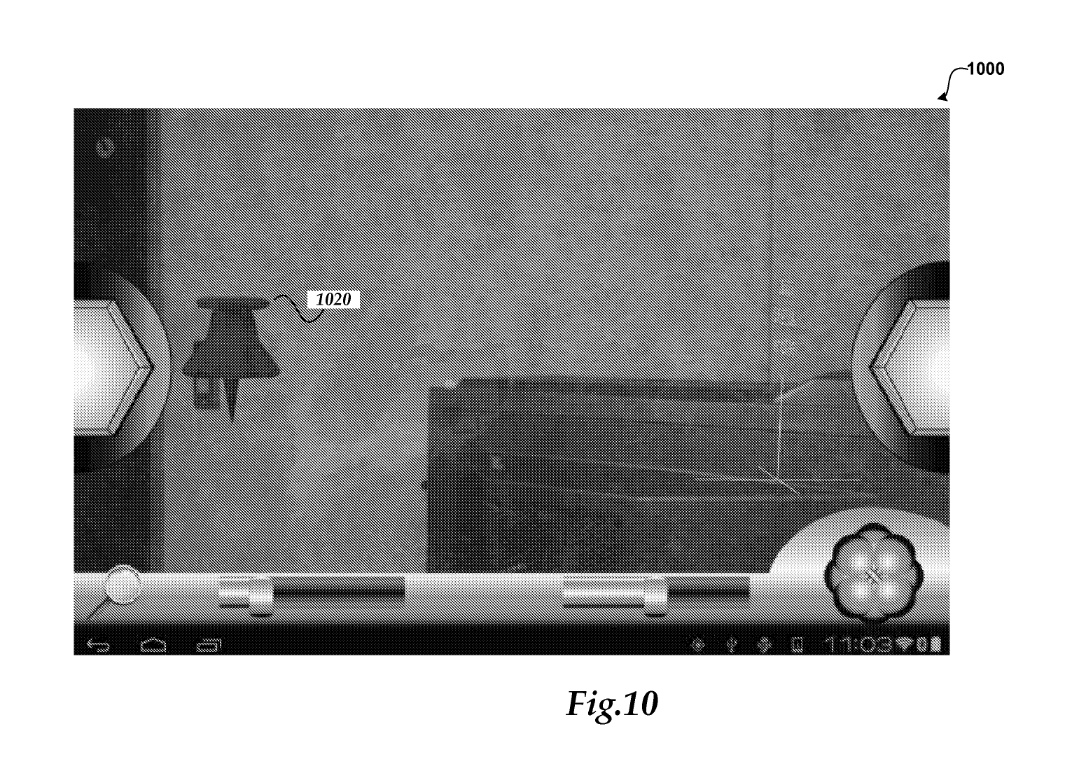

FIG. 10 shows placement of a virtual object. As illustrated, diagram 1000 shows a graphical display of a three dimensional thumbtack 1020 with a zoomed out display of a map. A user may move around virtual object 1020 as well as move above/beneath the virtual object 1020.

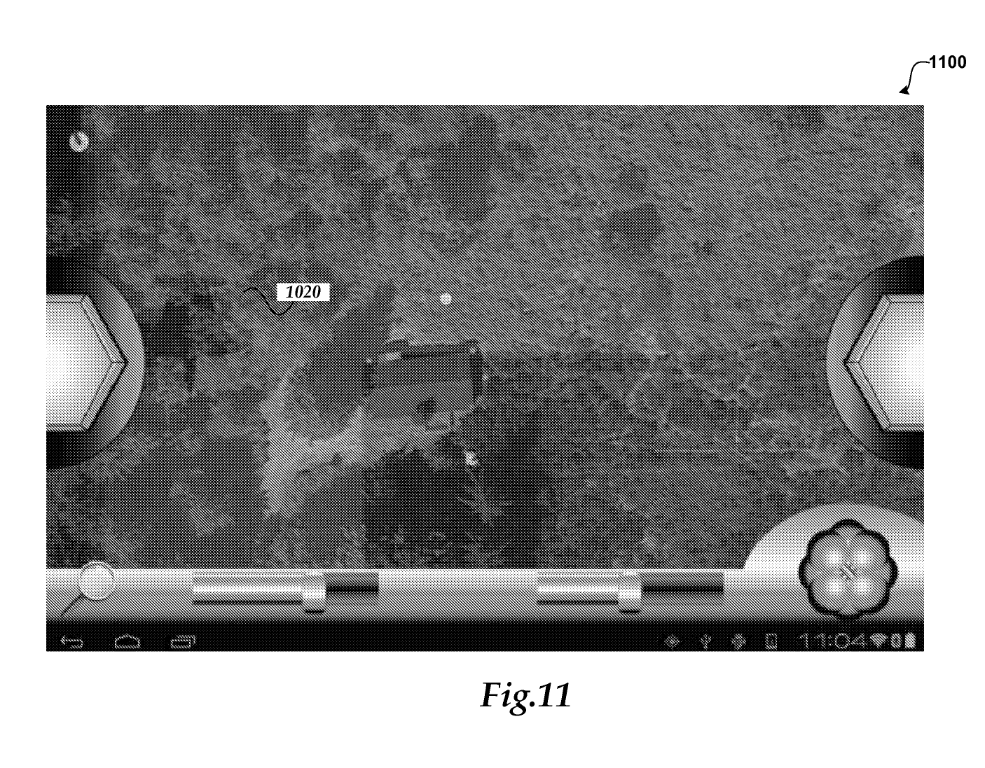

FIG. 11 shows a view of a virtual object. As illustrated, diagram 1100 shows a graphical display of a three dimensional thumbtack 1020 with more of the map view displayed as compared to the view in FIG. 10 that shows more of the AR view.

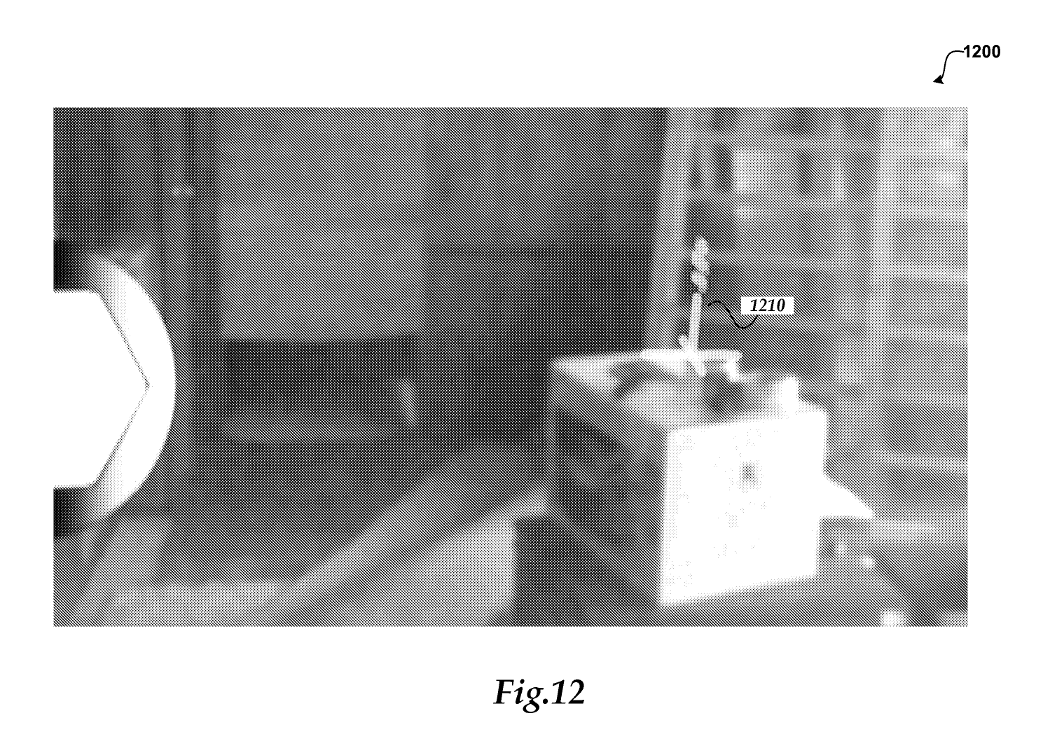

FIGS. 12-22 show an example of navigating an area that includes different virtual objects.

FIG. 12 shows a display 1200 that includes an AR view of a virtual object. As illustrated, virtual object 1210 represents the SE corner of a house in which the user is moving about. As can be seen, the virtual object 1210 is displayed in conjunction with the actual camera view of the room in the house thereby creating the AR view. In the current example, virtual object 1210 is shown as a three-dimensional axis that includes a name of the virtual object (e.g. SE corner), a unique identifier for the virtual object, and coordinates for the point. According to an embodiment, each virtual object is associated with a unique identifier.

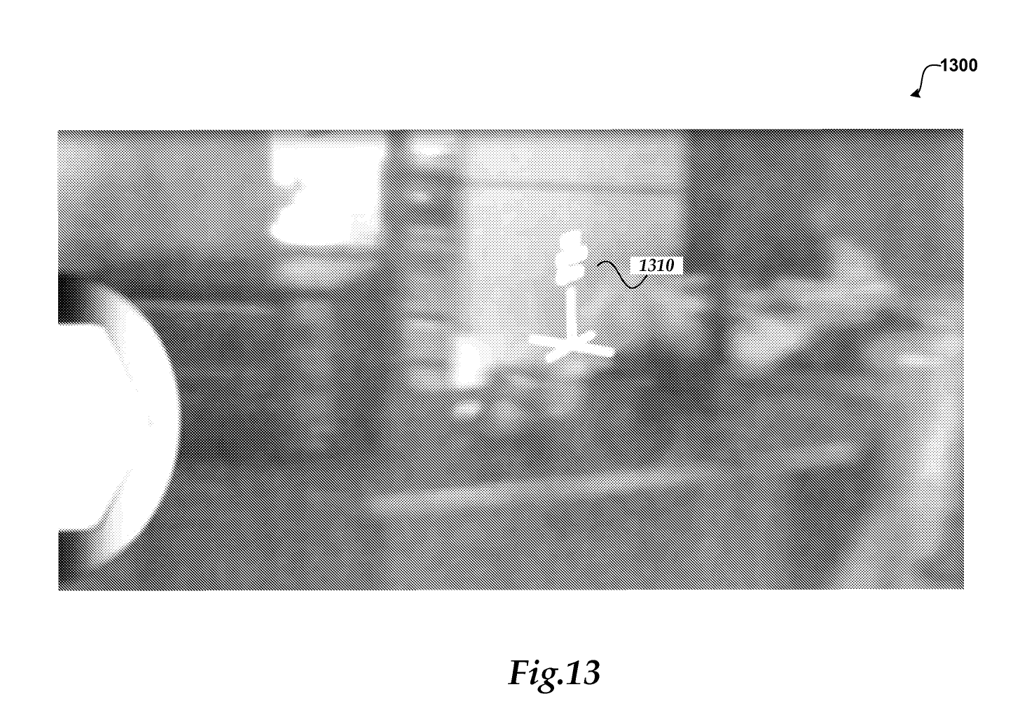

FIG. 13 shows a display 1300 that includes a view of a virtual object. As illustrated, virtual object 1310 represents the NE corner of a house in which the user is moving about.

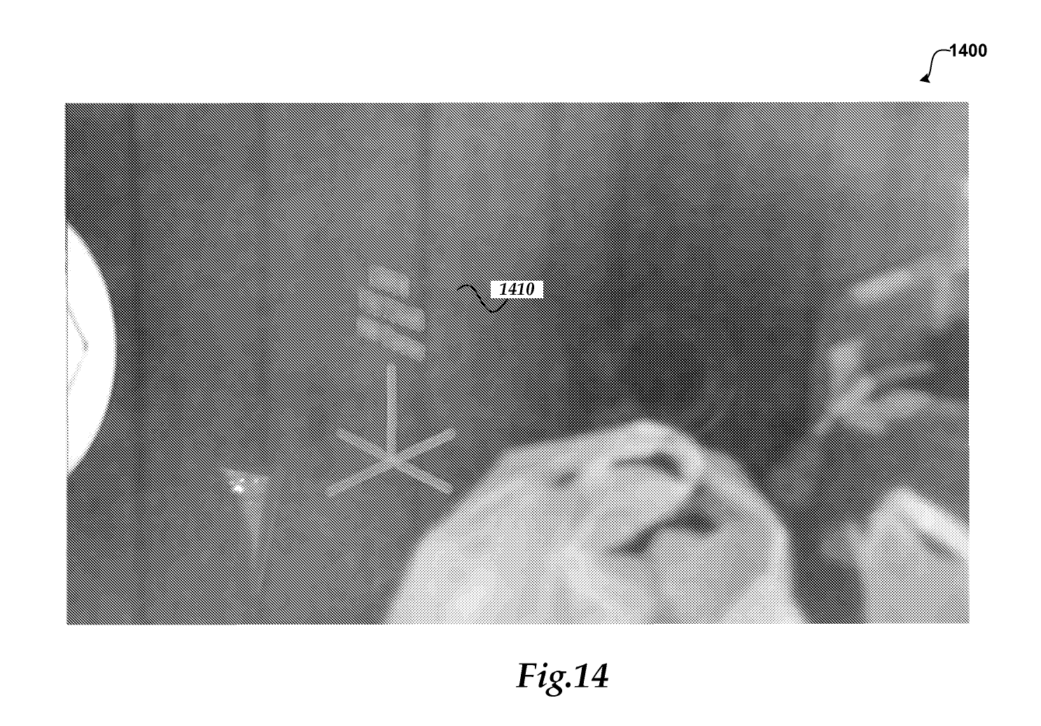

FIG. 14 shows a display 1400 that includes a view of a virtual object. As illustrated, virtual object 1410 represents the NW corner of a house in which the user is moving about.

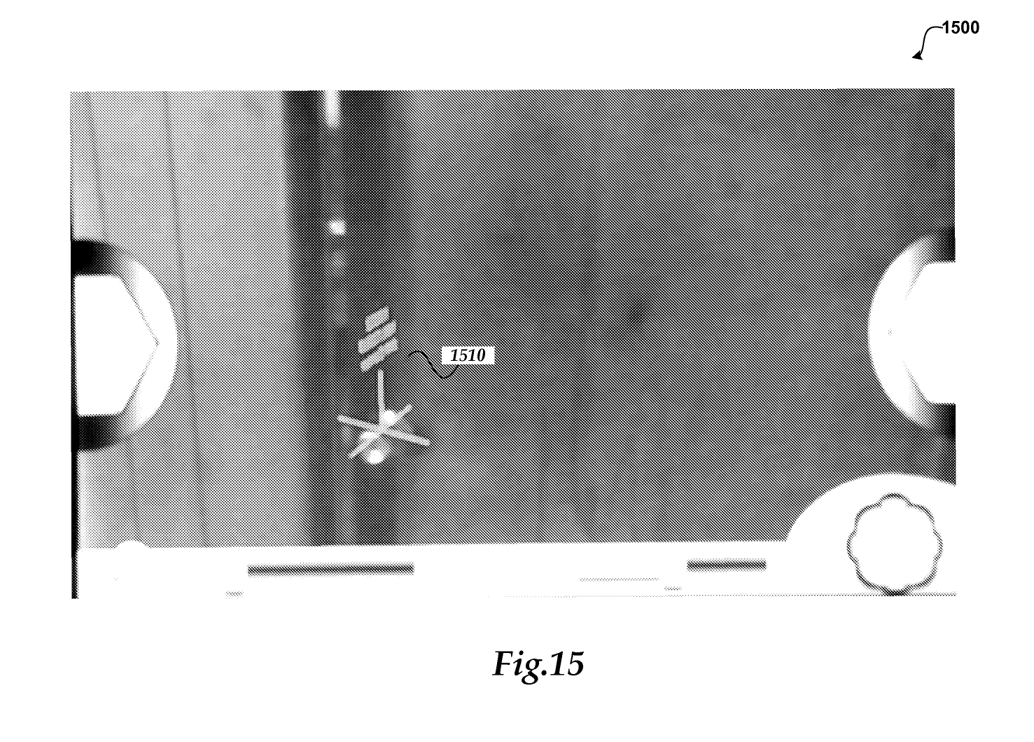

FIG. 15 shows a display 1500 that includes a view of a virtual object. As illustrated, virtual object 1510 represents the SW corner of a house in which the user is moving about.

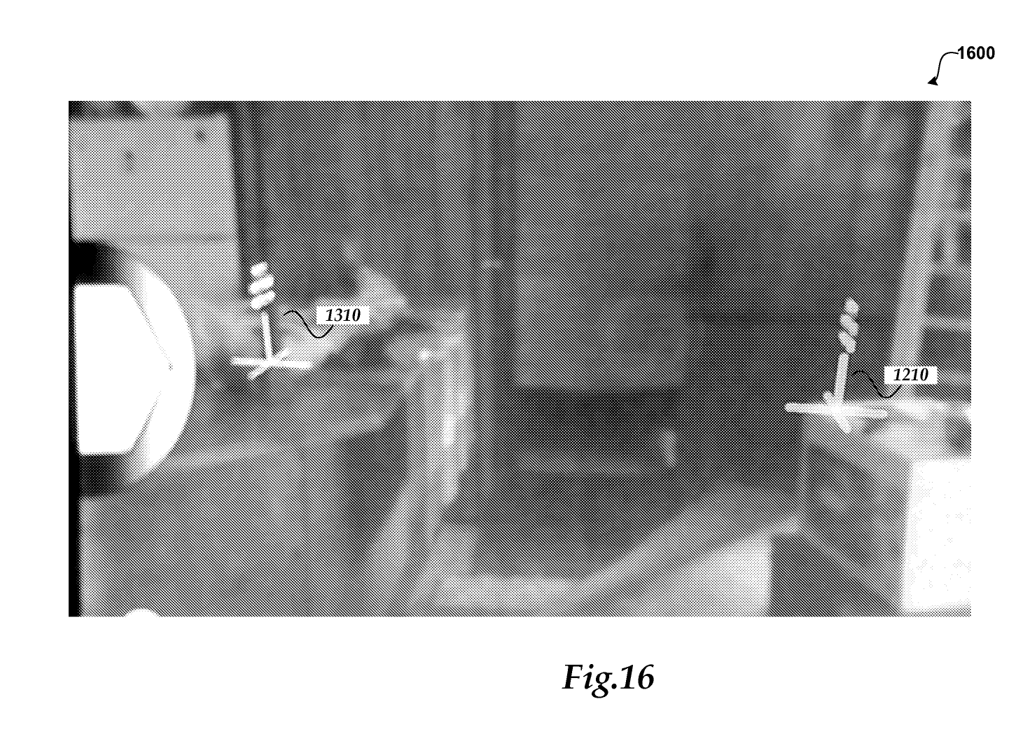

FIG. 16 shows a display 1600 that includes a view of two virtual objects. As illustrated, virtual object 1210 represents the SE corner and virtual object 1310 represents the NE corner of a house in which the user is moving about.

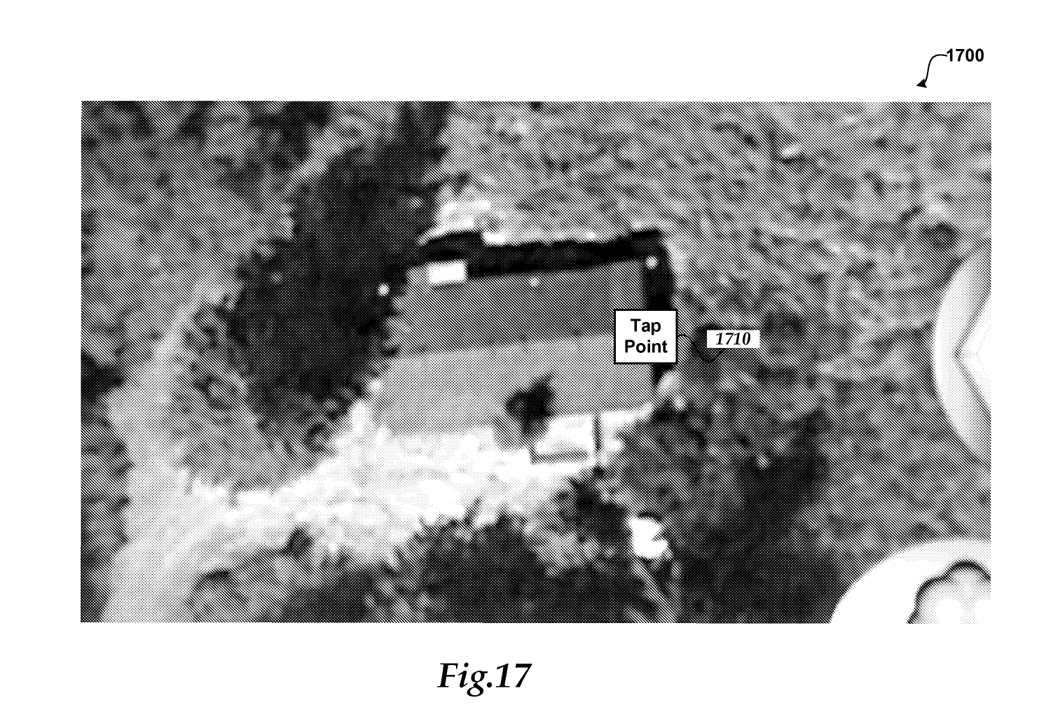

FIG. 17 shows a display 1700 that shows the map view of the house. In the current example, the user is manually selecting a location of a new virtual object by tapping on a location 1710 on the screen. A user may refine the location of the virtual object after tapping on the location. After tapping on the location, a user interface is displayed that allows a user to define the type of virtual object to display. In the current example, the user has selected a thumbtack (not shown).

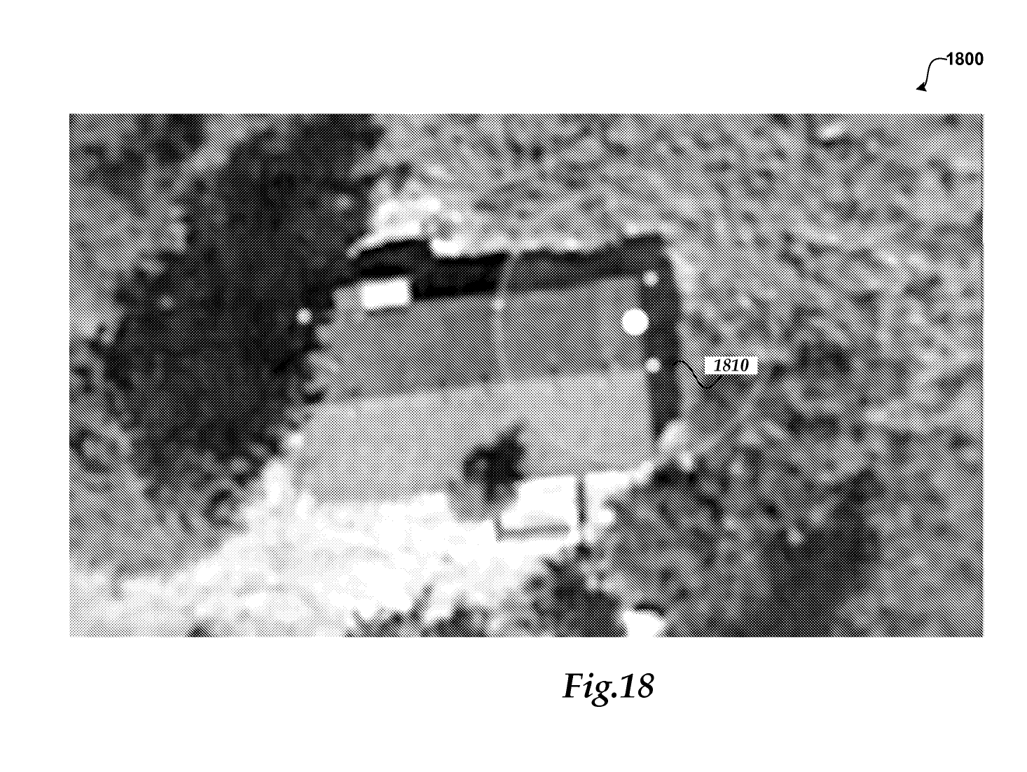

FIG. 18 shows a display 1800 that illustrates a new virtual object being placed. In the current example, the user has placed a new virtual object 1810 by tapping on location 1710 on the screen as illustrated in FIG. 17.

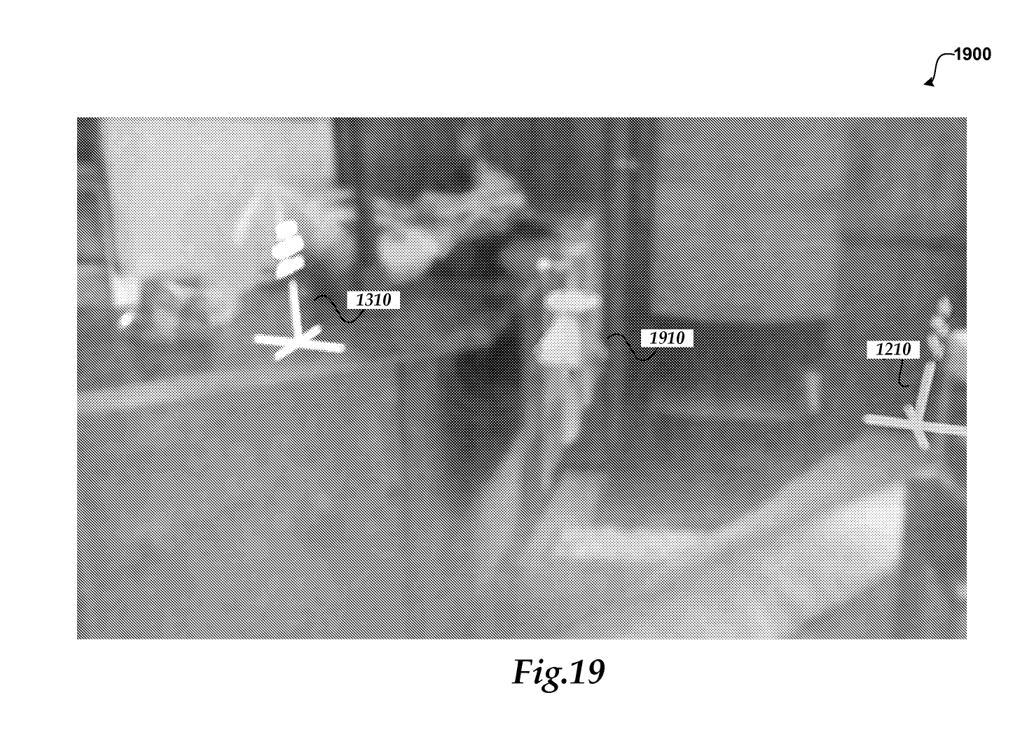

FIG. 19 shows a display 1900 that illustrates an augmented reality view of the new virtual object placed. After specifying the location and the type of virtual object, the user fades out the view of the map and switches to the AR view that shows a real time view including any virtual objects. In the current example, the AR view includes the two corners of the house and the newly inserted thumbtack 1910.

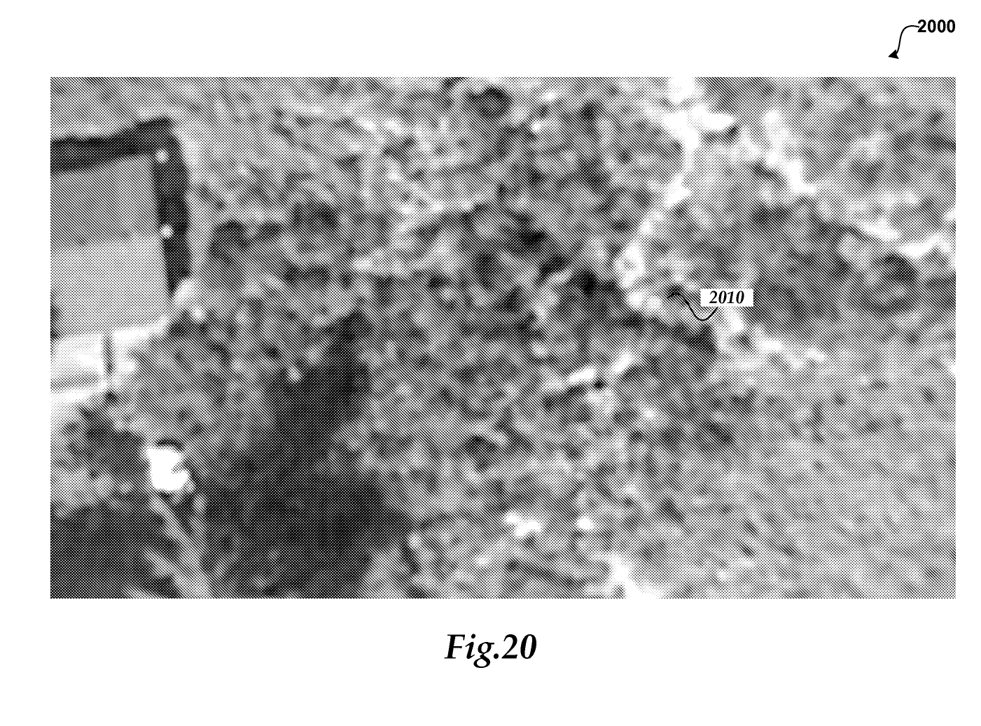

FIG. 20 shows a display 2000 that illustrates a new virtual object being placed. In the current example, the user has switched to the map view and placed a new virtual balloon object by tapping on location 2010 on the screen.

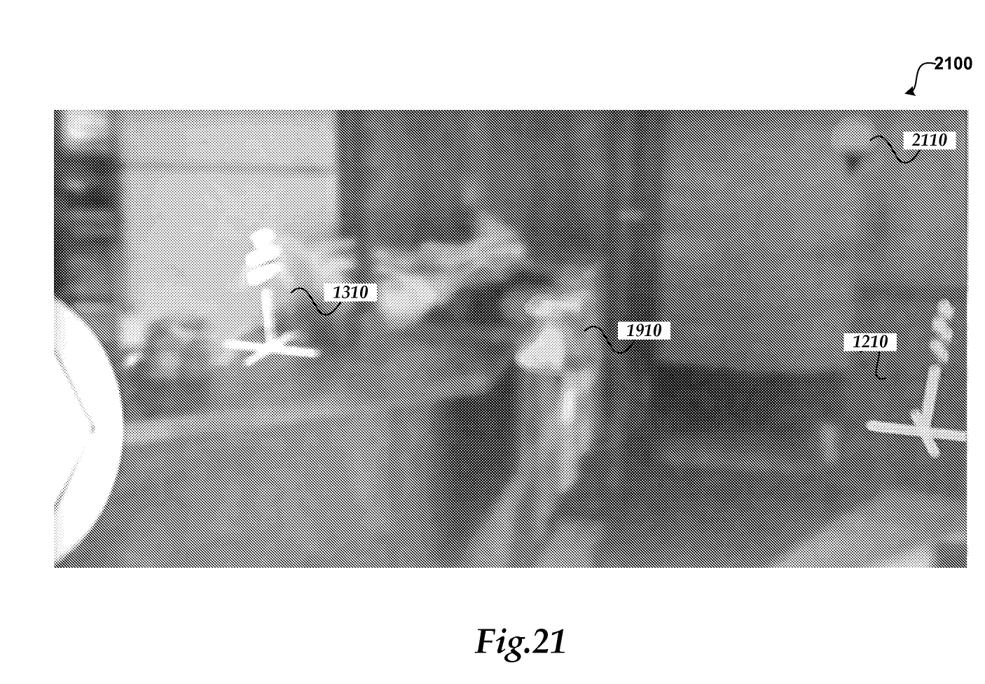

FIG. 21 shows a display 2100 that illustrates an augmented reality view of the new virtual object placed. In the current example, the AR view includes the two corners of the house, the thumbtack 1910, and the new balloon virtual object 2110 that is actually located outside of the walls of the house.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for displaying an augmented reality, comprising:
determining location information relating to a current location of a device;
determining corresponding State Plane Coordinates (SPC) using the location information;
mapping a location using the SPC; and
displaying a virtual object within a augmented reality (AR) view that displays a current camera view from the device with the virtual object when determined.

2. The method of claim 1, wherein determining the location information comprises determining Global Positioning System (GPS) coordinates for the current location of the device.

3. The method of claim 1, further comprising displaying a graphical user interface (GUI) on a display of the device that is used to change from a map view to the AR view.

4. The method of claim 3, further comprising determining a geofence that defines an area in which the virtual object is displayed or hidden.

5. The method of claim 4, wherein the geofence is associated with an entity such that only virtual objects associated with the entity are displayed or hidden within the area defined by the geofence.

6. The method of claim 1, further comprising defining a geofence that defines an area in which the virtual object is displayed or hidden by receiving input from the device.

7. The method of claim 1, further comprising setting a search scope for virtual objects based in a current field of view currently displayed.

8. The method of claim 1, wherein the virtual object is a three-dimensional graphical object that may be navigated around.

9. The method of claim 1, further comprising receiving a selection of a location of the virtual object on the device displaying the AR.

10. A computer-readable medium having computer-executable instructions for displaying an augmented reality, comprising:
determining a current location of a device;
determining corresponding State Plane Coordinates (SPC) for the current location;
mapping a location using the SPC; and
displaying a virtual object within a augmented reality (AR) view that displays a current camera view from the device with the virtual object when determined.

11. The computer-readable medium of claim 10, further comprising displaying a graphical user interface (GUI) on a display of the device that is used to change from a map view to the AR view and define location of one or more virtual objects.

12. The computer-readable medium of claim 10, further comprising determining a geofence that defines an area in which the virtual object is displayed or hidden.

13. The computer-readable medium of claim 12, wherein the geofence is associated with an entity such that only virtual objects associated with the entity are displayed or hidden within the area defined by the geofence.

14. The computer-readable medium of claim 10, further comprising searching for virtual objects that are located within a current field of view.

15. The computer-readable medium of claim 10, further comprising receiving a selection of a location of the virtual object on the device displaying the AR.

16. An apparatus for displaying an augmented reality, comprising:
a display;
a camera;
a network connection coupled to a server;
a processor and a computer-readable medium;
an operating environment stored on the computer-readable medium and executing on the processor; and
an application operating under the control of the operating environment and operative to actions comprising:
determining a current location of a device;
determining corresponding State Plane Coordinates (SPC) for the current location;
mapping a location using the SPC; and
displaying a virtual object within a augmented reality (AR) view that displays a current camera view from the cameral with the virtual object when determined.

17. The apparatus of claim 16, further comprising displaying a graphical user interface (GUI) on a display of the device that is used to change from a map view to the AR view and define location of one or more virtual objects and search for virtual objects that are located within a current field of view.

18. The apparatus of claim 16, further comprising determining a geofence that defines an area in which the virtual object is displayed or hidden.

19. The apparatus of claim 18, wherein the geofence is associated with an entity such that only virtual objects associated with the entity are displayed or hidden within the area defined by the geofence.

20. The apparatus of claim 16, wherein the virtual object is a three-dimensional graphical object.
